(19) United States
(12) Patent Application Publication
(10) Pub. No.: US 2018/0055075 A1
(43) Pub. Date: Mar. 1, 2018

(54) COMPOSITIONS AND METHODS OF PRESERVING MEAT SUBSTITUTES

(71) Applicant: Wisconsin Alumni Research Foundation, Madison, WI (US)

(72) Inventors: Mark P. RICHARDS, Madison, WI (US); Mark HARGROVE, Ames, IA (US); Nantawat TATIYABORWORNTHAM, Madison, WI (US); Jie YIN, Madison, WI (US); Wenjing ZHANG, Madison, WI (US)

(21) Appl. No.: 15/680,995

(22) Filed: Aug. 18, 2017

Related U.S. Application Data
(60) Provisional application No. 62/377,192, filed on Aug. 19, 2016.

(51) Int. Cl. A23L 3/34; A23L 33/185; A23L 19/00

(52) U.S. Cl. CPC A23L 3/34; A23V 2002/00; A23L 19/00; A23L 33/185

(57) ABSTRACT

The disclosure provides for compositions and methods for the preservation of meat substitutes containing plant heme protein. In particular, small molecules that can fit in the unique heme pocket of plant heme proteins are provided to stabilize and preserve meat substitutes the products.

### PRIORITY CLAIM

This application claims benefit of priority to U.S. Provisional Application Ser. No. 62/377,192, filed Aug. 19, 2016, the entire contents of which are hereby incorporated by reference.

### FEDERAL GRANT SUPPORT CLAUSE

This invention was made with government support under 2014-67017-21648 awarded by the USDA/NIFA. The government has certain rights in the invention.

### BACKGROUND OF THE DISCLOSURE

### 1. Field of the Disclosure

This disclosure relates to composition and methods for the preservation of meat substitutes products including plant heme protein. In particular, small molecules that react with the unique heme pocket of plant heme proteins reduce spoilage and preserve storage of such meat substitutes.

### 2. Related Art

Meat analogs, also called meat alternatives, meat substitutes, mock meats, faux meats, imitation meats, or vegetarian/vegan “meats” are designed to approximate certain aesthetic qualities (primarily texture, flavor and appearance) and/or chemical characteristics of specific types of meat. Many analogs are soy-based (tofu, tempeh) or gluten-based. The growing interest in healthy diets, risks of animal-borne disease and concerns over unethical animal management practices all make meat analogs more highly sought after.

Food preservation is a complicated process that requires both a means of preventing microbial contamination and a means of preventing the development of off-colors or off-flavors rendering the food unpalatable. Indeed, off-odor and off-flavor development during refrigerated and frozen storage of fish products is a major obstacle to consumer acceptance. The USDA estimates that more than 96 billion pounds of food in the U.S. were lost by retailers, foodservice, and consumers in 1995, and meat, poultry and fish made up 8.5% of that number—over 8 billion pounds. This problem also plagues the meat analog industry, and the off-color aspect of meat analogs is a particular problem that has not been adequately resolved.

### SUMMARY OF THE DISCLOSURE

Thus, in accordance with the present disclosure, there is provided a method of improving storage life of a plant heme-containing meat analog comprising contacting said meat analog with a heme-stabilizing agent. The heme-stabilizing agent may be contacted with said meat analog at a concentration of about 25 μmol/kg, about 50 μmol/kg, about 75 μmol/kg, about 100 μmol/kg, about 125 μmol/kg, about 150 μmol/kg, about 175 μmol/kg, about 200 μmol/kg, about 250 μmol/kg, about 300 μmol/kg, about 350 μmol/kg, about 400 μmol/kg, about 450 μmol/kg or about 500 μmol/kg of meat analog. The heme-stabilizing agent may be contacted with said meat analog at a concentration of no more than about 25 μmol/kg, about 50 μmol/kg, about 75 μmol/kg, about 100 μmol/kg, about 125 μmol/kg, about 150 μmol/kg, about 175 μmol/kg, about 200 μmol/kg, about 250 μmol/kg, about 300 μmol/kg, about 350 μmol/kg, about 400 μmol/kg, about 450 μmol/kg or about 500 μmol/kg of meat analog. The heme-stabilizing agent may be contacted with said meat analog at a concentration of about 25 μmol/kg to about μmol/kg, 1000 μmol/kg, about 100 μmol/kg to about 200 μmol/kg, or about 50 μmol/kg to about 250 μmol/kg of meat analog. The heme-stabilizing agent may be niacin, imidazole, 4-methyl imidazole, or histidine.

The method may further comprise contacting said meat analong with a reductant, such as erythorbate or ascorbic acid. The reductant may be contacted with said meat analog at a concentration of about 0.5 mmol/kg, 1 mmol/kg, 2 mmol/kg, 3 mmol/kg, 4 mmol/kg, 5 mmol/kg, 6 mmol/kg, 7 mmol/kg, 8 mmol/kg, 10 mmol/kg, 12 mmol/kg, 14 mmol/kg, 16 mmol/kg, 18 mmol/kg, 19 mmol/kg or 20 mmol/kg of meat analog, or no more than about 0.5 mmol/kg, 1 mmol/kg, 2 mmol/kg, 3 mmol/kg, 4 mmol/kg, 5 mmol/kg, 6 mmol/kg, 7 mmol/kg, 8 mmol/kg, 10 mmol/kg, 12 mmol/kg, 14 mmol/kg, 16 mmol/kg, 18 mmol/kg, 19 mmol/kg or 20 mmol/kg of meat analog. The reductant may be contacted with said meat analog at a concentration of about 0.5 to about 20 mmol/kg of meat analog, about 0.5 to about 15 mmol/kg of meat analog, about 0.5 to about 10 mmol/kg of meat analog, or about 1 to about 10 mmol/kg of meat analog.

The method may further comprise subjecting said meat analog to a high oxygen environment during packaging, such as about 80% O₂, optionally supplemented with CO₂. The method may also further comprise packaging said meat analog, wherein the packaged environment is a low oxygen environment, such as about 75% N₂/25% CO₂. The low oxyegen environment may comprise an oxygen scavenging agent (such as ascorbic acid/sodium ascorbate or erythorbate) or system, such as an aqueous, enzymic, scavenger system consisting of glucose/glucose oxidase/catalase. The method may further comprise freezing said meat analog. The meat analog may be treated at 0 to 6° C. The meat analog may be treated substantially in the absence of exogenous calcium. The method may further comprise treating said meat analog with a preservative, such as PLA2 enzyme and/or rosemary extract, and or further comprise treating said meat analog with an additive. The meat analog may retain red color and/or remains palatable at 0.6° C. for 2, 3, 4, 5, 6, 7, 8, 9, 10 or 14 days beyond the date upon which untreated meat analog would no longer retain red color and/or be palatable. The meat analog may retain red color and/or remains palatable at −20° C. for 2, 3, 4, 5, 6, 7, 8, 9, 10 or 14 months beyond the date upon which untreated meat analog would no longer retain red color and/or be palatable.

The method may further comprise adjusting the pH of the meat analog to about 6.0-6.8, to about 6.0-6.6, to about 6.0-6.3, or to about 6.0. 6.1, 6.2, 6.3, 6.4, 6.5, 6.6, 6.7 and 6.8. Adjusting pH may comprise adding an acid solution to the meat analog, such as hydrochloric acid solution, a sodium hydroxide acid solution, a citric acid solution, or sodium phosphate solution. The method may further comprise adding a buffering agent to stabilize pH of the meat analog. The method may further comprise contacting said meat analong with a reductant and/or further comprising subjecting said meat analog to a high oxygen environment during packaging.

In another embodiment, there is provided a meat analog containing plant hemoglobin protein and comprising about 50 to about 250 μmol/kg of an added heme-stabilizing agent. The heme-stabilizing agent may be present in said meat analog at a concentration of about 25 μmol/kg, about 50 μmol/kg, about 75 μmol/kg, about 100 μmol/kg, about 125 μmol/kg, about 150 μmol/kg, about 175 μmol/kg, about 200 μmol/kg, about 250 μmol/kg, about 300 μmol/kg, about 350 μmol/kg, about 400 μmol/kg, about 450 μmol/kg or about 500 μmol/kg of meat analog. The heme-stabilizing agent may be present in said meat analog at a concentration of no more than about 25 μmol/kg, about 50 μmol/kg, about 75 μmol/kg, about 100 μmol/kg, about 125 μmol/kg, about 150 μmol/kg, about 175 μmol/kg, about 200 μmol/kg, about 250 μmol/kg, about 300 μmol/kg, about 350 μmol/kg, about 400 μmol/kg, about 450 μmol/kg or about 500 μmol/kg of meat analog. The heme-stabilizing agent may be present in said meat analog at a concentration of about 25 μmol/kg to about μmol/kg 1000 μmol/kg, about 100 μmol/kg to about 200 μmol/kg, or about 50 μmol/kg to about 250 μmol/kg of meat analog. The heme-stabilizing agent may be niacin, imidazole, 4-methyl imidazole, or histidine.

The meat analog may further comprise a reductant, such as erythorbate or ascorbic acid. The reductant may be present in said meat analog at a concentration of about 0.5 mmol/kg, 1 mmol/kg, 2 mmol/kg, 3 mmol/kg, 4 mmol/kg, 5 mmol/kg, 6 mmol/kg, 7 mmol/kg, 8 mmol/kg, 10 mmol/kg, 12 mmol/kg, 14 mmol/kg, 16 mmol/kg, 18 mmol/kg, 19 mmol/kg or 20 mmol/kg of meat analog, or no more than about 0.5 mmol/kg, 1 mmol/kg, 2 mmol/kg, 3 mmol/kg, 4 mmol/kg, 5 mmol/kg, 6 mmol/kg, 7 mmol/kg, 8 mmol/kg, 10 mmol/kg, 12 mmol/kg, 14 mmol/kg, 16 mmol/kg, 18 mmol/kg, 19 mmol/kg or 20 mmol/kg of meat analog. The reductant may be contacted with said meat analog at a concentration of about 0.5 to about 20 mmol/kg of meat analog, about 0.5 to about 15 mmol/kg of meat analog, about 0.5 to about 10 mmol/kg of meat analog, or about 1 to about 10 mmol/kg of meat analog.

The meat analog may further comprise a preservative and/or an additive. The preservative may be PLA2 enzyme and/or rosemary extract. The meat analog may have a pH of about 6.0-6.8, about 6.0-6.6, about 6.0-6.3, or about 6.0. 6.1, 6.2, 6.3, 6.4, 6.5, 6.6, 6.7 and 6.8. The meat analog may further comprise a buffering agent to stabilize pH of the meat analog.

In yet another embodiment, there is provided a method of preparing a storage stable meat analog comprising (a) providing a meat analog; (b) treating said meat analog with about 50 to about 250 μmol/kg of meat analog of a heme-stabilizing agent; and (c) packaging said meat analog for sale. The step of providing may be the actual preparation of the meat analog, or merely providing a previously prepared meat analog. The method further comprise contacting said meat analog with at least one additional additive or preservation agent prior to step (c), such as where the preservative is PLA2 enzyme and/or rosemary extract. The method may further comprise freezing said meat analog after step (c). Step (b) may comprise treatment at −20 to 6° C.

The heme-stabilizing agent may be niacin, imidazole, 4-methyl imidazole, or histidine. The heme-stabilizing agent may be contacted with said meat analog at a concentration of about 25 μmol/kg, about 50 μmol/kg, about 75 μmol/kg, about 100 μmol/kg, about 125 μmol/kg, about 150 μmol/kg, about 175 μmol/kg, about 200 μmol/kg, about 250 μmol/kg, about 300 μmol/kg, about 350 μmol/kg, about 400 μmol/kg, about 450 μmol/kg or about 500 μmol/kg of meat analog. The heme-stabilizing agent may be contacted with said meat analog at a concentration of no more than about 25 μmol/kg, about 50 μmol/kg, about 75 μmol/kg, about 100 μmol/kg, about 125 μmol/kg, about 150 μmol/kg, about 175 μmol/kg, about 200 μmol/kg, about 250 μmol/kg, about 300 μmol/kg, about 350 μmol/kg, about 400 μmol/kg, about 450 μmol/kg or about 500 μmol/kg of meat analog. The heme-stabilizing agent may be contacted with said meat analog at a concentration of about 25 μmol/kg to about μmol/kg 1000 μmol/kg, about 100 μmol/kg to about 200 μmol/kg, or about 50 μmol/kg to about 250 μmol/kg of meat analog.

The method may further comprise contacting said meat analong with a reductant, such as erythorbate or ascorbic acid. The reductant may be contacted with said meat analog at a concentration of about 0.5 mmol/kg, 1 mmol/kg, 2 mmol/kg, 3 mmol/kg, 4 mmol/kg, 5 mmol/kg, 6 mmol/kg, 7 mmol/kg, 8 mmol/kg, 10 mmol/kg, 12 mmol/kg, 14 mmol/kg, 16 mmol/kg, 18 mmol/kg, 19 mmol/kg or 20 mmol/kg of meat analog, or no more than about 0.5 mmol/kg, 1 mmol/kg, 2 mmol/kg, 3 mmol/kg, 4 mmol/kg, 5 mmol/kg, 6 mmol/kg, 7 mmol/kg, 8 mmol/kg, 10 mmol/kg, 12 mmol/kg, 14 mmol/kg, 16 mmol/kg, 18 mmol/kg, 19 mmol/kg or 20 mmol/kg of meat analog. The reductant may be contacted with said meat analog at a concentration of about 0.5 to about 20 mmol/kg of meat analog, about 0.5 to about 15 mmol/kg of meat analog, about 0.5 to about 10 mmol/kg of meat analog, or about 1 to about 10 mmol/kg of meat analog.

The method may further comprise subjecting said meat analog to a high oxygen environment during packaging, such as about 80% O₂, optionally supplemented with CO₂. The method may also further comprise packaging said meat analog, wherein the packaged environment is a low oxygen environment, such as about 75% N₂/25% CO₂. The low oxyegen environment may comprise an oxygen scavenging agent (such as ascorbic acid/sodium ascorbate, erythorbate, or a metal) or system, such as an aqueous, enzymic, scavenger system consisting essentially of glucose/glucose oxidase/catalase. The meat analog may be s treated substantially in the absence of exogenous calcium. The packaged meat analog may retain red color and/or remains palatable at 0.6° C. for 2, 3, 4, 5, 6, 7, 8, 9, 10 or 14 days beyond the date upon which untreated meat analog would no longer retain red color and/or be palatable.

The method may further comprise adjusting the pH of the meat analog to about 6.0-6.8, to about 6.0-6.6, to about 6.0-6.3, or to about 6.0. 6.1, 6.2, 6.3, 6.4, 6.5, 6.6, 6.7 and 6.8. Adjusting pH may comprise adding an acid solution to the meat analog, such as hydrochloric acid solution, a sodium hydroxide acid solution, a citric acid solution, or sodium phosphate solution. The method may further comprise adding a buffering agent to stabilize pH of the meat analog. The method may further comprise contacting said meat analong with a reductant and/or further comprising subjecting said meat analog to a high oxygen environment during packaging.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.” The word “about” means plus or minus 5% of the stated number.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF THE FIGURES

The following drawings form part of the present specification and are included to further demonstrate certain aspects of the present disclosure. The disclosure may be better understood by reference to one or more of these drawings in combination with the detailed description of the disclosure that follows.

FIG. 1—Color stability of meat analog. Treatments: Water (W); 2.5 mmol/kg tissue Niacin (NA). Packaging: High oxygen package (80% O₂, 20% CO₂). Water content: 3% water capacity. Days under light (˜300 ft): 4 days under light display at 1-3° C.

FIG. 2—Effect of pH and different molar ratios of niacin to soybean Hb on the redness of Lba solutions. Measurement after exposure to 35 fc of light for 4 days

FIG. 3—Effect of high oxygen during packaging. The ability of niacin to stabilize color in meat analog was lost as the sample was transferred from 80% O₂/20% CO₂ packaging at day 4 (top left) to an air-permeable overwrap packaging for assessment at day 8 (top right). Meat analog treated with niacin (NA) maintained color up to day 11 days when storage was entirely in 80% O₂/20% CO₂ during light display (bottom images). Ascorbic acid (AA)+Niacin (NA) had somewhat better color than niacin alone in the high oxygen packaging (bottom images). AA alone did not stabilize color. W-water added. All samples were stored at 1-3° C. during light display (300 foot candles).

### DESCRIPTION OF ILLUSTRATIVE EMBODIMENTS

The disclosure provides a method of using certain natural substances to prevent oxidation of plant hemoglobin (Hb). For example, niacin is a b-vitamin that fits in the distal heme pocket of the plant Hb and coordinates with the iron atom of the heme moiety. So long as the iron atom can be maintained in the reduced state, the hemoglobin containing bound niacin will retain a red color, which is desired when presenting the product to mimic raw hamburger. Bound niacin will also likely prevent oxidation of lipids, thereby protecting flavor of the product during refrigerated and frozen storage. Preliminary data shows that as little as 2.5 mmol/kg of niacin allows meat analog to retain a pink color for four days. Since there is ˜150 μmol plant heme protein/kg meat (wet weight), as little as 150 μmol niacin/kg meat (wet weight) should protect color. These and other aspects of the disclosure are set out in detail below.

### I. Meat Analogs

Meat analogs, also called meat alternatives, meat substitutes, mock meat, faux meat, imitation meat, or (where applicable) vegetarian meat or vegan meat, approximates certain aesthetic qualities (primarily texture, flavor and appearance) and/or chemical characteristics of specific types of meat. Many analogues are soy-based or gluten-based.

Generally, meat analogs are understood to mean a food made from non-meats, sometimes even without other animal products, such as dairy. The market for meat imitations includes vegetarians, vegans, non-vegetarians seeking to reduce their meat consumption for health or ethical reasons, and people following religious dietary laws in Judaism, Islam, Hinduism, and Buddhism.

In particular, meat analogs with added heme protein (e.g., plant heme) are defined as non-meat products containing plant heme protein in a range of 1 to 5 mg/g. The rough amounts of heme proteins in poultry (0.2-3 mg/g), pork (1-3 mg/g) and beef (3-5 mg/g) may be used as approximate levels of added heme protein that would be needed to provide red color to the meat analog. The heme proteins that impart color in meat products will be similar to the milligrams of plant heme protein that would need to be added to a meat analog to impart red color.

The following is a list of various types of meat analogs: Alpro and (known for their plant milk range, also offer different vegetarian meat substitutes); Beanfeast; Beyond Meat; Boca Burger; Falafel; Ganmodoki; Gardein; Gardenburger; Glamorgan sausage; Jackfruit, Koya-dofu; Leaf protein concentrate; Mock duck; Nut roast; Okara; Paneer; Quorn; Tempeh; Tofu; Tofurkey; Welsh rarebit; Wheat gluten.

### II. Preservation Compositions

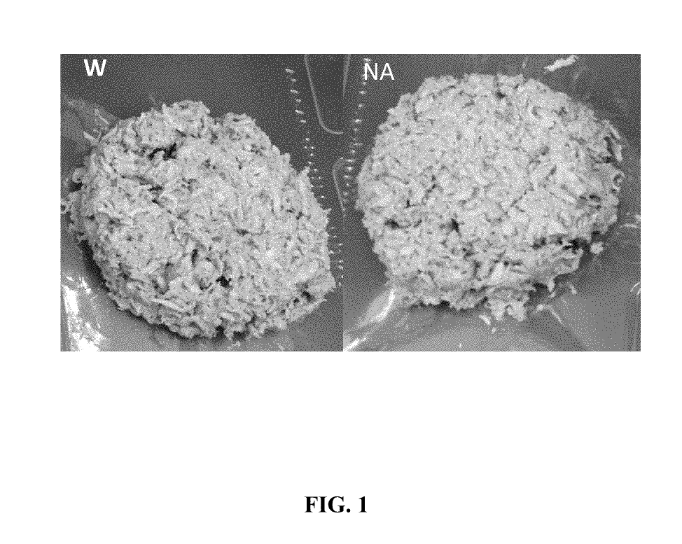

In accordance with the present disclosure, there are provided compositions containing food grade small molecules such as niacin, and optionally other preservatives, and further, where such agents are combined with plant heme containing meat substitutes. The niacin will bind to the iron atom of the heme moiety within the plant Hb. Bound niacin results in better color stability during light display of the meat analog compared to control meat analog without added niacin (see FIG. 1).

In some embodiments, a reducing agent will be added in sufficient amount to reduce the iron atom in the heme moiety of the plant heme protein and maintain the iron of the heme in the reduced state during storage of the meat analog containing added niacin. A typical concentration of reductant would be 0.5 to 20 mmol/kg meat analog. For sodium ascorbate, this would be 0.1-4.0 g/kg meat analog.

Packaging in modified atmospheres can better allow niacin to remain fixed to the iron atom of the heme moiety within the plant Hb as well as keep the iron atom reduced to provide optimal color. Therefore, high oxygen atmosphere packaging (e.g., 80% O₂/20% CO₂) that is routinely used in the meat industry will be used to stabilize niacin in the heme pocket of the plant Hb.

Conversion to an O₂-depleted atmosphere can also limit release of niacin form the iron atom of the heme moiety within the plant Hb. Thus, an oxygen scavenging system can be used. Generally, the meat analog is packaged in an atmosphere of 75% N₂/25% CO₂ and an oxygen scavenger is needed to remove the last traces of O₂ that remain in the packaged meat analog product. In general, the oxygen scavenger is provided at an amount sufficient to reduce spoilage, stabilize the meat substitute against color change, extend shelf life and/or inhibit oxidation. Such amounts (in a solution) will range from 30 mg glucose/1 mg glucose oxidase/0.1 mg catalase to 300 mg glucose/5 mg glucose oxidase/0.5 mg catalase, and it particular will employ not to exceed amounts of about 60 mg glucose/1 mg glucose oxidase/0.1 mg catalase, 90 mg glucose/1 mg glucose oxidase/0.1 mg catalase, 60 mg glucose/2 mg glucose oxidase/0.2 mg catalase, 60 mg glucose/3 mg glucose oxidase/0.3 mg catalase, 60 mg glucose/4 mg glucose oxidase/0.4 mg catalase and 200 mg glucose/5 mg glucose oxidase/0.5 mg catalase. In general, the enzyme solution is placed in a highly gas permeable film that retains liquid. The film containing the enzyme solution is part of the packaging system, typically in the lid of the packaging.

Commercially available sachets containing iron-filings can also be used to scavenge the traces of oxygen that remain in the package. The sachet is affixed to the inner wall of the packaging.

The high oxygen packaging or the oxygen scavenger technique may be employed to achieve an increase in shelf life of 10%, 20%, 30%, 40%, 50%, 60%, 70%, 80%, 90%, 100%, 150%, 200%, 250%, 500%, 750%, 1000% or more. The oxygen scavenger may be employed to achieve an increase in shelf life by 1 day, 2 days, 3 days, 4 days, 5 days, 6 days, 7 days, 8 days, 9 days, 10 days, two weeks, three weeks or more. The oxygen scavenger may be employed to achieve a decrease in oxidation of 10%, 20%, 30%, 40%, 50%, 60%, 70%, 80%, 90%, or 100% when measured at 24 hours, 48 hours, 72 hours or one week following treatment.

A. Heme-Stabilizing Agents

Various heme-stabilizing agents are contemplated for use in accordance with the present disclosure. A few of these are mentioned below.

1. Niacin

Niacin, also known as vitamin B₃ and nicotinic acid, is an organic compound with the formula C₆H₅NO₂ and, depending on the definition used, one of the 20 to 80 essential human nutrients. Pharmaceutical and supplemental niacin are primarily used to treat hypercholesterolemia (high cholesterol) and pellagra (niacin deficiency). Insufficient niacin in the diet can cause nausea, skin and mouth lesions, anemia, headaches, and tiredness. The lack of niacin may also be observed in pandemic deficiency disease, which is caused by a lack of five crucial vitamins (niacin, vitamin C, thiamin, vitamin D, and vitamin A) and is usually found in areas of widespread poverty and malnutrition. Niacin has not been found to be useful in decreasing the risk of cardiovascular disease in those already on a statin but appears to be effective in those not taking a statin.

This colorless, water-soluble solid is a derivative of pyridine, with a carboxyl group (COOH) at the 3-position. Other forms of vitamin B₃ include the corresponding amide and nicotinamide (“niacinamide”), where the carboxyl group has been replaced by a carboxamide group (CONH₂), as well as more complex amides and a variety of esters. Niacin and niacinamide are convertible to each other with steady world demand rising from 8,500 tonnes per year in the 1980s to 40,000 in recent years.

Niacin cannot be directly converted to nicotinamide, but both compounds are precursors of the coenzymes nicotinamide adenine dinucleotide (NAD) and nicotinamide adenine dinucleotide phosphate (NADP) in vivo. NAD converts to NADP by phosphorylation in the presence of the enzyme NAD+ kinase. NADP and NAD are coenzymes for many dehydrogenases, participating in many hydrogen transfer processes. NAD is important in catabolism of fat, carbohydrate, protein, and alcohol, as well as cell signaling and DNA repair, and NADP mostly in anabolism reactions such as fatty acid and cholesterol synthesis. High energy requirements (brain) or high turnover rate (gut, skin) organs are usually the most susceptible to their deficiency. Although the two are identical in their vitamin activity, nicotinamide does not have the same pharmacological effects (lipid modifying effects) as niacin. Nicotinamide does not reduce cholesterol or cause flushing. As the precursor for NAD and NADP, niacin is also involved in DNA repair.

The Food and Nutrition Board of the U.S. Institute of Medicine updated Estimated Average Requirements (EARs) and Recommended Dietary Allowances (RDAs) for niacin in 1998. The current EARs for niacin for women and men ages 14 and up are 11 mg/day and 12 mg/day, respectively; the RDAs are 14 and 16 mg/day, respectively. RDAs are higher than EARs so as to identify amounts that will cover people with higher than average requirements. RDA for pregnancy equals 18 mg/day. RDA for lactation equals 17 mg/day. For infants up to 12 months, the Adequate Intake (AI) is 2-4 mg/day. For children ages 1-13 years, the RDA increases with age from 6 to 12 mg/day. As for safety, the Food and Nutrition Board also sets Tolerable Upper Intake Levels (known as ULs) for vitamins and minerals when evidence is sufficient. In the case of niacin the UL is set at 35 mg/day. The European Food Safety Authority reviewed the same safety question and set its UL at 10 mg/day. Safety issues are presented at length in the Side Effects section. Collectively the EARs, RDAs, AIs and ULs are referred to as Dietary Reference Intakes.

For U.S. food and dietary supplement labeling purposes the amount in a serving is expressed as a percentage of Daily Value (% DV). Daily Values were based on 1968 RDAs and have not been updated even though RDAs have gone through several changes. For niacin labeling purposes 100% of the Daily Value is 20 mg. Thus, for an adult woman, 100% DV from a food or supplement would be 143% of her RDA and 181% of her EAR. A table of adult Daily Values is provided at Reference Daily Intake.

2. Imidazole and 4-Methyl Imidazole

Imidazole is an organic compound with the formula (CH)₂N(NH)CH. It is a white or colourless solid that is soluble in water, producing a mildly alkaline solution. In chemistry, it is an aromatic heterocycle, classified as a diazole, and having non-adjacent nitrogen atoms.

Many natural products, especially alkaloids, contain the imidazole ring. These imidazoles share the 1,3-C₃N₂ ring but feature varied substituents. This ring system is present in important biological building-blocks, such as histidine and the related hormone histamine. Many drugs contain an imidazole ring, such as certain antifungal drugs, the nitroimidazole series of antibiotics, and the sedative midazolam.

When fused to a pyrimidine ring, it forms purine, which is the most widely occurring nitrogen-containing heterocycle in nature.

Imidazole is a planar 5-membered ring. It exists in two equivalent tautomeric forms, because the positive charge can be located on either of the two nitrogen atoms. Imidazole is a highly polar compound, as evidenced by its electric dipole moment of 3.67 D. It is highly soluble in water. The compound is classified as aromatic due to the presence of a sextet of π-electrons, consisting of a pair of electrons from the protonated nitrogen atom and one from each of the remaining four atoms of the ring. Some resonance structures of imidazole are shown below:

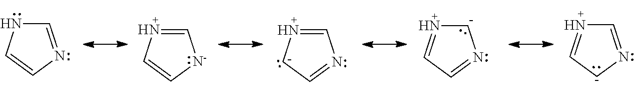

Imidazole is amphoteric. That is, it can function as both an acid and as a base. As an acid, the pKₐ of imidazole is 14.5, making it less acidic than carboxylic acids, phenols, and imides, but slightly more acidic than alcohols. The acidic proton is located on N-1. As a base, the pKₐ of the conjugate acid (cited above as pK_{BH}⁺ to avoid confusion between the two) is approximately 7, making imidazole approximately sixty times more basic than pyridine. The basic site is N-3. Protonation gives the imidazolium cation, which is symmetrical.

Imidazole is incorporated into many important biological molecules. The most pervasive is the amino acid histidine, which has an imidazole side-chain. Histidine is present in many proteins and enzymes and plays a vital part in the structure and binding functions of hemoglobin. Imidazole-based histidine compounds play a very important role in intracellular buffering. Histidine can be decarboxylated to histamine, which is also a common biological compound. It can cause urticaria (hives), when histamine is produced during allergic reaction. The relationship between histidine and histamine are shown below:

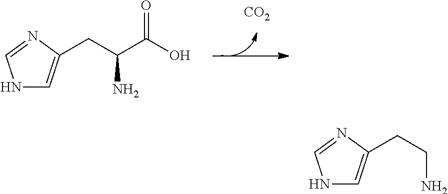 [SMILES: N[C@@H](Cc1c[nH]cn1)C(=O)O ; "CO2" ; NCCc1c[nH]cn1]

One of the applications of imidazole is in the purification of His-tagged proteins in immobilised metal affinity chromatography (IMAC). Imidazole is used to elute tagged proteins bound to Ni ions attached to the surface of beads in the chromatography column. An excess of imidazole is passed through the column, which displaces the His-tag from nickel co-ordination, freeing the His-tagged proteins.

Imidazole has become an important part of many pharmaceuticals. Synthetic imidazoles are present in many fungicides and antifungal, antiprotozoal, and antihypertensive medications. Imidazole is part of the theophylline molecule (found in tea leaves and coffee beans) that stimulates the central nervous system. It is present in the anticancer medication mercaptopurine, which combats leukemia by interfering with DNA activities.

A number of substituted imidazoles, including clotrimazole, are selective inhibitors of nitric oxide synthase, which makes them interesting drug targets in inflammation, neurodegenerative diseases and tumors of the nervous system. Other biological activities of the imidazole pharmacophore relate to the downregulation of intracellular Ca++ and K+ fluxes, and interference with translation initiation.

The substituted imidazole derivatives are valuable in treatment of many systemic fungal infections. Imidazoles belong to the class of azole antifungals, which includes ketoconazole, miconazole, and clotrimazole.

For comparison, another group of azoles is the triazoles, which includes fluconazole, itraconazole, and voriconazole. The difference between the imidazoles and the triazoles involves the mechanism of inhibition of the cytochrome P450 enzyme. The N3 of the imidazole compound binds to the heme iron atom of ferric cytochrome P450, whereas the N4 of the triazoles bind to the heme group. The triazoles have been shown to have a higher specificity for the cytochrome P450 than imidazoles, thereby making them more potent than the imidazoles.

4-Methylimidazole (4-MeI or 4-MEI) is a heterocyclic organic chemical compound with molecular formula H₃C—C₃H₃N₂ or C₄H₆N₂. It is formally derived from imidazole through replacement of the hydrogen in position 4 by a methyl group. It is a slightly yellowish solid. 4-MeI may be formed in the browning of certain foods through the Maillard reaction between carbohydrates and amino-containing compounds. In particular, it is found in roasted foods, grilled meats, coffee and in types of caramel coloring produced with ammonia-based processes. It may arise also by fermentation.

4-MeI may be prepared using the Debus-Radziszewski imidazole synthesis, by reacting methylglyoxal with ammonia and formaldehyde. It may also be prepared by the reaction of hydroxyacetone and formamide in ammonia. Small energy difference separates 4-methylimidazole from its tautomer 5-methylimidazole.

3. Histidine

Histidine (abbreviated as His or H; encoded by the codons CAU and CAC) is an α-amino acid that is used in the biosynthesis of proteins. It contains an α-amino group (which is in the protonated —NH₃⁺ form under biological conditions), a carboxylic acid group (which is in the deprotonated —COO⁻ form under biological conditions), and a side chain imidazole, classifying it as a positively charged (at physiological pH). Initially thought essential only for infants, longer-term studies have shown it is essential for adults also.

The conjugate acid (protonated form) of the imidazole side chain in histidine has a pKₐ of approximately 6.0. This means that, at physiologically relevant pH values, relatively small shifts in pH will change its average charge. Below a pH of 6, the imidazole ring is mostly protonated as described by the Henderson-Hasselbalch equation. When protonated, the imidazole ring bears two NH bonds and has a positive charge. The positive charge is equally distributed between both nitrogens and can be represented with two equally important resonance structures. As the pH increases past approximately 6, one of the protons is lost. The remaining proton of the now-neutral imidazole ring can reside on either nitrogen, giving rise to what are known as the N1-H or N3-H tautomers. The N3-H tautomer is protonated on the #3 nitrogen, farther from the amino acid backbone bearing the amino and carboxyl groups, whereas the N1-H tautomer is protonated on the nitrogen nearer the backbone.

The imidazole ring of histidine is aromatic at all pH values. It contains six pi electrons: four from two double bonds and two from a nitrogen lone pair. It can form pi stacking interactions, but is complicated by the positive charge. It does not absorb at 280 nm in either state, but does in the lower UV range more than some amino acids.

The imidazole side chain of histidine is a common coordinating ligand in metalloproteins and is a part of catalytic sites in certain enzymes. It has the ability to switch between protonated and unprotonated states, which allows histidine to participate in acid-base catalysis. In catalytic triads, the basic nitrogen of histidine is used to abstract a proton from serine, threonine, or cysteine to activate it as a nucleophile. In a histidine proton shuttle, histidine is used to quickly shuttle protons. It can do this by abstracting a proton with its basic nitrogen to make a positively charged intermediate and then use another molecule, a buffer, to extract the proton from its acidic nitrogen. In carbonic anhydrases, a histidine proton shuttle is utilized to rapidly shuttle protons away from a zinc-bound water molecule to quickly regenerate the active form of the enzyme. Histidine is also important in hemoglobin in helices E and F. Histidine assists in stabilizing oxyhemoglobin and destabilising CO-bound hemoglobin. As a result, carbon monoxide binding is only 200 times stronger in haemoglobin, compared to 20,000 times stronger in free heme.

B. Reductants

As discussed above, some embodiments will employ a reducing agent added to reduce the iron atom in the heme moiety, thereby maintaining the iron of the heme in the reduced state during storage. Examples of reductants are sodium ascorbate/ascorbic acid and erythorbate.

1. Ascorbic Acid and Sodium Ascorbate

Ascorbic acid is a naturally occurring organic compound with antioxidant properties. It is a white solid, but impure samples can appear yellowish. It dissolves well in water to give mildly acidic solutions. Ascorbic acid is one form (“vitamer”) of vitamin C. It was originally called L-hexuronic acid, but, when it was found to have vitamin C activity in animals (“vitamin C” being defined as a vitamin activity, not then a specific substance), the suggestion was made to rename it. The new name, ascorbic acid, is derived from a- (meaning “no”) and scorbutus (scurvy), the disease caused by a deficiency of vitamin C. Because it is derived from glucose, many non-human animals are able to produce it, but humans require it as part of their nutrition. Other vertebrates which lack the ability to produce ascorbic acid include some primates, guinea pigs, teleost fishes, bats, and some birds, all of which require it as a dietary micronutrient (that is, in vitamin form).

Ascorbic acid is classed as a reductone. The ascorbate anion is stabilized by electron delocalization, as shown above in terms of resonance between two canonical forms. For this reason, ascorbic acid is much more acidic than would be expected if the compound contained only isolated hydroxyl groups.

The ascorbate ion is the predominant species at typical biological pH values. It is a mild reducing agent and antioxidant. It is oxidized with loss of one electron to form a radical cation and then with loss of a second electron to form dehydroascorbic acid. It typically reacts with oxidants of the reactive oxygen species, such as the hydroxyl radical. Such radicals are damaging to animals and plants at the molecular level due to their possible interaction with nucleic acids, proteins, and lipids. Sometimes these radicals initiate chain reactions. Ascorbate can terminate these chain radical reactions by electron transfer. Ascorbic acid is special because it can transfer a single electron, owing to the resonance-stabilized nature of its own radical ion, called semidehydroascorbate. The net reaction is:

RO′+C₆H₇O₆—→RO⁻+C₆H₇O_{6′}→ROH+C₆H₆O₆

The oxidized forms of ascorbate are relatively unreactive and do not cause cellular damage. However, being a good electron donor, excess ascorbate in the presence of free metal ions can not only promote but also initiate free radical reactions, thus making it a potentially dangerous pro-oxidative compound in certain metabolic contexts.

On exposure to oxygen, ascorbic acid will undergo further oxidative decomposition to various products including diketogulonic acid, xylonic acid, threonic acid and oxalic acid.

Ascorbic acid and its sodium, potassium, and calcium salts are commonly used as antioxidant food additives. These compounds are water-soluble and, thus, cannot protect fats from oxidation: For this purpose, the fat-soluble esters of ascorbic acid with long-chain fatty acids (ascorbyl palmitate or ascorbyl stearate) can be used as food antioxidants. Eighty percent of the world's supply of ascorbic acid is produced in China.

The relevant European food additive E numbers are:
E300 ascorbic acid (approved for use as a food additive in the EU USA and Australia and New Zealand)
E301 sodium ascorbate (approved for use as a food additive in the EU USA and Australia and New Zealand)
E302 calcium ascorbate (approved for use as a food additive in the EU USA and Australia and New Zealand)
E303 potassium ascorbate
E304 fatty acid esters of ascorbic acid (i) ascorbyl palmitate (ii) ascorbyl stearate.
   Ascorbic acid creates volatile compounds when mixed with glucose and amino acids in 90° C. It is a cofactor in tyrosine oxidation.

Sodium erythorbate (C₆H₇NaO₆) is a food additive used predominantly in meats, poultry, and soft drinks. Chemically, it is the sodium salt of erythorbic acid. When used in processed meat such as hot dogs and beef sticks, it increases the rate at which nitrite reduces to nitric oxide, thus facilitating a faster cure and retaining the pink coloring. As an antioxidant structurally related to vitamin C, it helps improve flavor stability and prevents the formation of carcinogenic nitrosamines.

When used as a food additive, its E number is E316. The use of erythorbic acid and sodium erythorbate as a food preservative has increased greatly since the U.S. Food and Drug Administration banned the use of sulfites as preservatives in foods intended to be eaten fresh (such as ingredients for fresh salads) and as food processors have responded to the fact that some people are allergic to sulfites. Sodium erythorbate is produced from sugars derived from different sources, such as beets, sugar cane, and corn.

Alternative applications include the development of additives that could be utilized as anti-oxidants in general. For instance, this substance has been implemented in the development of active packaging.

2. Erythorbate

Erythorbate, or sodium erythorbate (C₆H₇NaO₆) is a food additive used predominantly in meats, poultry, and soft drinks. Chemically, it is the sodium salt of erythorbic acid. When used in processed meat such as hot dogs and beef sticks, it increases the rate at which nitrite reduces to nitric oxide, thus facilitating a faster cure and retaining the pink coloring. As an antioxidant structurally related to vitamin C, it helps improve flavor stability and prevents the formation of carcinogenic nitrosamines. When used as a food additive, its E number is E316. The use of erythorbic acid and sodium erythorbate as a food preservative has increased greatly since the U.S. Food and Drug Administration banned the use of sulfites as preservatives in foods intended to be eaten fresh (such as ingredients for fresh salads) and as food processors have responded to the fact that some people are allergic to sulfites. Alternative applications include the development of additives that could be utilized as anti-oxidants in general. For instance, this substance has been implemented in the development of corrosion inhibitors for metals and it has been implemented in active packaging. Sodium erythorbate is produced from sugars derived from different sources, such as beets, sugar cane, and corn.

3. Commercially Available Reductants Products/Systems

There are a number of commercially available options for reductants on the market. These include the Ageless® (iron sachet) and Ageless® OMAC (iron-containing film) products from Mitsubishi Gas Chemical America, Freshcare (sticker or sachet), and oxygen aborbing packets from U-LINE.

C. Additional Preservation Agents

In accordance with the present disclosure, niacin may be used with a reductant such as sodium ascorbate and/or with rosemary for the purpose preserving meat analogs and rendering them more stable during storage. The use of low concentrations of both niacin and rosemary in the compositions are contemplated. It is envisioned that only about 20 ppm of niacin will be applied to the meat analog in combination with only about 200 ppm rosemary extract. Also contemplated are no more than about 300 ppm rosemary extract, no more than about 225 ppm rosemary extract, 175 ppm rosemary extract, and 150 ppm rosemary extract, a range of about 150 ppm rosemary extract up to about 300 ppm rosemary extract, about 175 ppm to about 225 ppm rosemary extract, and about 190 ppm to about 210 ppm rosemary extract. Each of the foregoing values and ranges may be combined with about 10 ppm niacin, about 15 ppm niacin, about 20 ppm of niacin, about 25 ppm of niacin, about 30 ppm of niacin, about 10 to about 30 ppm of niacin, about 15 to about 25 ppm of niacin or about 18 to about 22 ppm of niacin. Niacin is water soluble which will allow it to be easily incorporated into meat analogs.

Food grade buffers (sodium, potassium, acetates, gluconates) and protein stabilizers may be used to stabilize pH of the solution (consisting of plant heme protein, reductant, and niacin/niacin-like molecule) and maintain the plant heme protein structure sbefore adding the solution to the solid plant-based materials used to mimic meat.

D. Other Additives

When meat and meat analogs that are industrially processed for consumption may be enriched with additives to protect or modify flavor or color, to improve its tenderness, juiciness or cohesiveness, or to aid with its preservation. Additives include the following:
Salt is the most frequently used additive in meat processing. It imparts flavor but also inhibits microbial growth, extends the product's shelf life and helps emulsifying finely processed products, such as sausages. Ready-to-eat products normally contain about 1.5 to 2.5 percent salt.
Nitrite is used in curing meat to stabilize the meat's color and flavor, and inhibits the growth of spore-forming microorganisms such as C. botulinum.
Phosphates used in meat processing are normally alkaline polyphosphates such as sodium tripolyphosphate. They are used to increase the water-binding and emulsifying ability of proteins, but also limit lipid oxidation and flavor loss, and reduce microbial growth.
Sweeteners such as sugar or corn syrup impart a sweet flavor, bind water and assist surface browning during cooking in the Maillard reaction.
Seasonings impart or modify flavor. They include spices or oleoresins extracted from them, herbs, vegetables and essential oils.
Flavorings such as monosodium glutamate impart or strengthen a particular flavor.
Tenderizers break down collagens to make the product more palatable for consumption. They include proteolytic enzymes, acids, salt and phosphate.
Dedicated antimicrobials include lactic, citric and acetic acid, sodium diacetate, acidified sodium chloride or calcium sulfate, cetylpyridinium chloride, activated lactoferrin, sodium or potassium lactate, or bacteriocins such as nisin.
Antioxidants include a wide range of chemicals that limit lipid oxidation, which creates an undesirable “off flavor,” in precooked meat products.
Acidifiers, most often lactic or citric acid, can impart a tangy or tart flavor note, extend shelf-life, tenderize the product or help with protein denaturation and moisture release.

E. pH Control

As shown in the examples below, the inventor has determined that reducing pH below neutral levels can further improve storage stability of plant-based meat analogs. In general, the goal would be to establish a pH of about 6.0, although any adjustment below neutral pH, such as 6.0-6.8, or even lower, will be effective. Specific pH values of 6.0. 6.1, 6.2, 6.3, 6.4, 6.5, 6.6, 6.7 and 6.8 are contemplated.

A dilute solution (e.g., hydrochloric acid or sodium hydroxide) can be used to effectively adjust the pH to a range of 6.0-6.6. There presence of histidine (pKa ˜6) in plant proteins of the meat analog will function to hold the material at the desired pH. Alternatively, a buffer such as citric acid with a pKa of 5.4 (buffer range of 4.4 to 6.4) would workd for pH 6.0 and pH 6.3. Sodium phosphate has a pKa of 7.2 (buffer range 6.2-8.2), which would be suitable for for pH 6.3 and pH 6.6.

The acids will be, for example, diluted in an aqueous material used in the formulation process, and then mixed with other ingredients to form the meat analog.

### III. Methods of Preserving Meat Analogs

Surface applications are expected for certain products (e.g., calcium-alginate casing onto breakfast sausage analog). Niacin will be incorporated into the solution containing calcium alginate that sets up as an edible casing. For ground products (e.g., hamburger analog) the niacin and reductant (e.g., in solution) can be incorporated during mixing of materials and dry ingredients with allowable water. For relatively large pieces of meat analog that are to be cooked intact and then shredded after cooking, the solution may be included in the brine that is injected prior to cooking. Ice cold solutions can be used in all cases, and ice cold temperature is common practice during addition of solutions to meat and meat analog products.

It is also possible that high oxygen partial pressure will better allow niacin to remain fixed to the iron atom of the heme moiety within the plant Hb as well as keep the iron atom reduced to provide optimal color. Therefore, modified atmosphere packaging (e.g., 80% O₂/20% CO₂) can be used to further improve color and lipid stability.

Conversion to an O₂ depleted atmosphere can also limit release of niacin form the iron atom of the heme moiety within the plant Hb. Thus, aqueous solutions of oxygen scavengers may be impregnated in a packaging material or coated on packaging surface. Alternatively, the oxygen scavengers may be included in a sachet or other receptable that is placed inside of a package prior to sealing.

### IV. Examples

The following examples are included to demonstrate particular embodiments of the disclosure. It should be appreciated by those of skill in the art that the techniques disclosed in the examples which follow represent techniques discovered by the inventor to function well in the practice of the disclosure, and thus can be considered to constitute particular modes for its practice. However, those of skill in the art should, in light of the present disclosure, appreciate that many changes can be made in the specific embodiments which are disclosed and still obtain a like or similar result without departing from the spirit and scope of the disclosure.

### Example 1—Materials and Methods

The small molecule (e.g., niacin) is mixed with the plant Hb solution. Niacin (123 mg to 1000 mg) is added per 1 L solution of plant Hb in which there is about 15 g plant Hb. The plant Hb containing bound niacin is then added to the solid plant protein/plant fat matrix to make the final composition. The 123 mg niacin per 15 g of plant Hb should be enough niacin to bind all of the heme of the plant Hb. Higher amounts of niacin could be added to provide a reservoir of additional niacin if needed to provide better color stability.

The reductant is either added to the plant Hb solution containing niacin or to the solid plant protein/plant fat matrix. The reductant concentration (e.g., sodium ascorbate) is used at 0.1 to 4.0 g per kg of meat analog.

The niacin can also be added to the solid plant protein/plant fat matrix already containing the added plant Hb. There is approximately 150 μmol of plant heme/kg meat analog. Therefore, a targeted final concentration of niacin would be 150 μmol/kg meat analog, which is equivalent to 18.5 mg niacin per kg meat analog.

### Example 2—Results

Niacin is added to the meat analog already containing the plant Hb (soybean hemoglobin; Lba) and the product is stored under lights in high oxygen packaging during 4 days of refrigerated storage. The meat analog without added niacin turns brown during 4 days of light display, while the meat analog containing added niacin retains a superior color (FIG. 1).

In addition, the inventors generated data showing that niacin inhibits plant Hb denaturation (as masured by turbidity value) on its own, as well as in conjunction with a high oxygen atmosphere:
Lba (turbidity value—0.1155)
Lba+NA (turbidity value—0.0173)
Lba+NA+O₂ (turbidity value—0.0001)
   Storage condition was 4 days at 37° C. during ambient light.

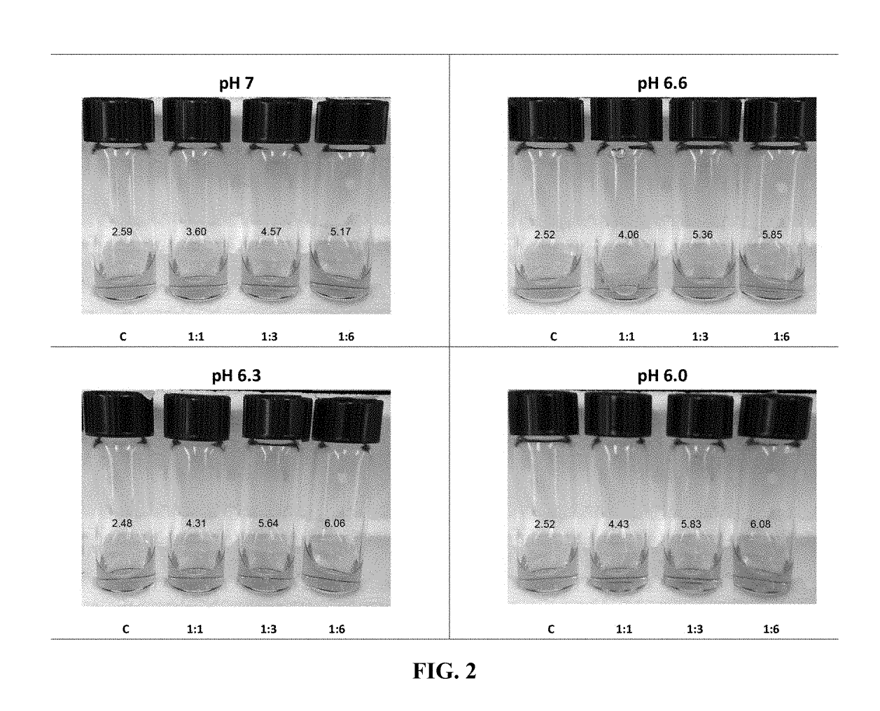

A 1:1 (niacin:Lba) ratio stabilized red color better than control with no niacin (Table 1, FIG. 2). Increasing the ratio of niacin:Lba increased redness (Table 1, FIG. 2), while decreasing pH increased redness (Table 2, FIG. 2). Thus, these data suggest the niacin dose can be as low as 150 μmol/kg meat analog (1:1 ratio) and that higher ratios work better (e.g., 480 and 960 μmol/kg). 100 grams of meat analog containing a 3:1 dose of niacin would provide 5.9 mg niacin; a 6:1 dose would provide 11.8 mg niacin.

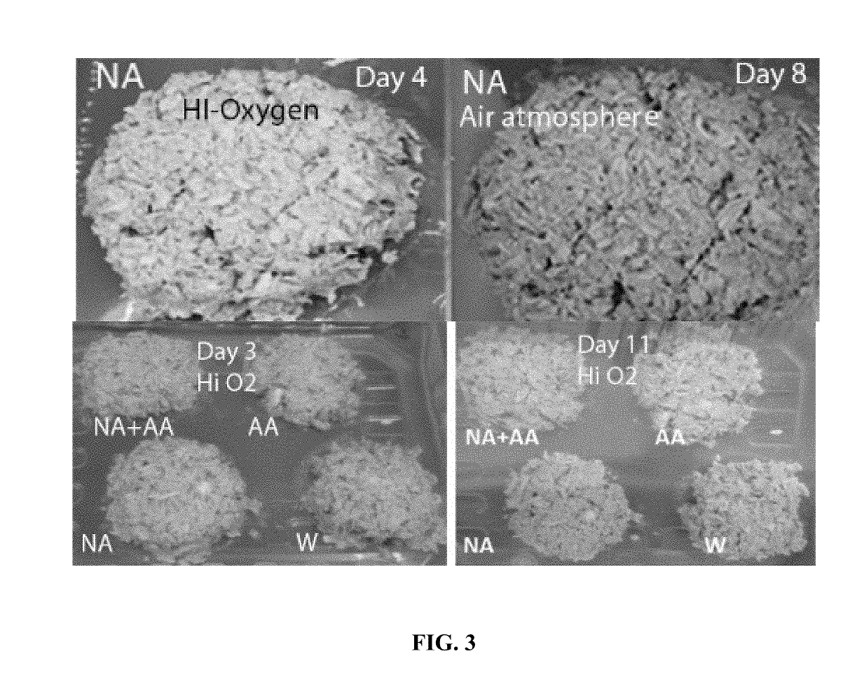

In a meat analog matrix, there was evidence that high oxygen packaging stabilized color more effectively than in a normal air atmosphere (FIG. 3). It also appeared that niacin+ascorbic acid maintained red color in the meat analog better than niacin alone (FIG. 3).

TABLE 1
Effect of different molar ratios of niacin to soybean Hb on the redness
of Lba solutions after exposure to 35 fc of light for 4 days.

| | Redness (a-value) |
|---|---|
| niacin:Lba (molar ratio) | at day 4 |
| 0:1 | 2.52d |
| 1:1 | 4.10c |
| 3:1 | 5.35b |
| 6:1 | 5.79a |

There was no interaction between pH and niacin amount so that the main effects could be compared statistically.
Treatments with the same letter designation are not significantly different (p<0.05)

TABLE 2
Effect of pH on the redness of Lba solutions
after exposure to 35 fc of light for 4 days.

| | Redness (a-value) |
|---|---|
| pH | at day 4 |
| 7.0 | 3.99c |
| 6.6 | 4.45b |
| 6.3 | 4.62ab |
| 6.0 | 4.72a |

There was no interaction between pH and niacin amount so that the main effects could be compared statistically.
Treatments with the same letter designation are not significantly different (p<0.05)

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

1. A method of improving storage life of a plant heme-containing meat analog comprising contacting said meat analog with a heme-stabilizing agent.

2. The method of claim 1, wherein said heme-stabilizing agent is contacted with said meat analog at a concentration of about 150 μmol/kg of meat analog.

3. The method of claim 1, wherein said heme-stabilizing agent is contacted with said meat analog at a concentration of no more than about 500 μmol/kg of meat analog.

4. The method of claim 1, wherein said heme-stabilizing agent is contacted with said meat analog at a concentration of about 50 to about 250 μmol/kg of meat analog.

5. The method of claim 1, wherein said heme stabilizing agent is niacin, imidazole, 4-methyl imidazole, or histidine.

6. The method of claim 1, further comprising contacting said meat analong with a reductant.

7-9. (canceled)

10. The method of claim 1, further comprising subjecting said meat analog to a high oxygen environment during packaging.

11. (canceled)

12. The method of claim 1, further comprising packaging said meat analog, wherein the packaged environment is a low oxygen environment.

13. (canceled)

14. The method of claim 1, further comprising freezing said meat analog.

15. The method of claim 1, wherein said meat analog is treated at 0 to 6° C.

16. The method of claim 1, wherein said meat analog is treated substantially in the absence of exogenous calcium.

17. The method of claim 1, further comprising treating said meat analog with a preservative.

18. (canceled)

19. The method of claim 1, further comprising treating said meat analog with an additive.

20. The method of claim 1, wherein said meat analog retains red color and/or remains palatable at 0.6° C. for 2, 3, 4, 5, 6, 7, 8, 9, 10 or 14 days beyond the date upon which untreated meat analog would no longer retain red color and/or be palatable.

21. The method of claim 1, further comprising adjusting the pH of the meat analog to about 6.0-6.8, to about 6.0-6.6, to about 6.0-6.3, or to about 6.0. 6.1, 6.2, 6.3, 6.4, 6.5, 6.6, 6.7 and 6.8.

22. The method of claim 21, wherein adjusting pH comprises adding an acid solution to the meat analog.

23. (canceled)

24. The method of claim 21, further comprising adding a buffering agent to stabilize pH of the meat analog.

25. The method of claim 21, further comprising contacting said meat analong with a reductant and/or further comprising subjecting said meat analog to a high oxygen environment during packaging.

26. A meat analog containing plant hemoglobin protein and comprising about 50 to about 250 μmol/kg of an added heme-stabilizing agent.

27-40. (canceled)

41. A method of preparing a storage stable meat analog comprising:
(a) providing a meat analog;
(b) treating said meat analog with about 50 to about 250 μmol/kg of meat analog of a heme-stabilizing agent; and
(c) packaging said meat analog for sale.

42-65. (canceled)
